(19) United States
(12) Patent Application Publication
(10) Pub. No.: US 2010/0043694 A1
(43) Pub. Date: Feb. 25, 2010

(54) Tamper evident indicating devices

(76) Inventor: Gordhanbhai N. Patel, Middlesex, NJ (US)

Correspondence Address: Barbara V.Maurer, 5 Haven Hill Rise, Flamington, NJ, 08822, US

(21) Appl. No.: 12/454,192

(22) Filed: May 13, 2009

Related U.S. Application Data
(60) Provisional application No. 61/090,419, filed on Aug. 20, 2008.

(51) Int. Cl. G01D 21/00; B32B 37/26

(52) U.S. Cl. 116/201; 116/207; 156/60

(57) ABSTRACT

A variety of indicators, e.g., time, temperature, time-temperature, freeze, thaw and sterilization are reported and used for monitoring quality of perishables. However, these indicators are tamperable, e.g., an indicator can be opened, removed, repositioned, exchanged or replaced. Disclosed are tamper evident time, temperature, time-temperature, freeze, thaw, sterilization and like indicating devices. If an indicator is tampered, it will be either destroyed or will provide a visual indication or a message, such as “VOID” or “TAMPERED”.

### CROSS REFERENCE TO RELATED APPLICATIONS

The present application claims priority to pending U.S. Provisional Patent Application No. 61/090,419, filed May 14, 2008, which is incorporated herein by reference in its entirety.

### FIELD OF THE INVENTION

The present invention relates to tamper-evident time, temperature, time-temperature, freeze, thaw and sterilization indicating devices, e.g., for monitoring quality of perishables and medical supplies.

### BACKGROUND OF THE INVENTION

Perishable products have measurable shelf-lives, which are usually expressed within specified limits as the time left for available end use. By the term “perishable products” is meant herein to include perishable foods having a measurable shelf life such as fresh, refrigerated, and frozen, vegetables, fruits, meats, fish, poultry, dairy products, bakery products, juices, pre-cooked foods, soft and alcoholic beverages, and also including nonfood items having shelf lives ranging from a few hours to some years including pharmaceuticals, vaccines, sera, blood, blood plasma, cosmetics, reactive chemical compounds, biochemical products, batteries, x-ray film and photographic films. Thus there are several means known in the art to measure shelf-lives of products.

Whenever a clock or timer is impractical or too expensive to use, color changing time. indicators in form of label, stickers or badges are often used. Indicators for monitoring the passage of a relative amount of time are referred herein to as time indicator or time indicating device (TI). These indicators include, but are not limited, to visual validation of time, safety sticker, self-timing retail sticker, biological industrial processes monitoring, self-expiring stickers to prevent re-use, security ID labels, visitors badges, self-expiring parking tags, package and shipping labels, wrist bands, time indicating tickets for trains, buses, spot events, theaters etc, self-expiring passes for tours, emergency rooms, hospitals, museums, and other locations, race track passes, security labels for screened luggage, purses, bags at airports to show the aircraft control people that the particular items were inspected, unmanned but video controlled entrances for visitors where the self-expiring visitor label issued electronically. These devices also include TIs for limited-use items for consumers, for example, items that once opened or in use should be used within certain period, including but not limited to drinks, food items, health, personal and family care products.

Also known are certain time-temperature indicator (TTI) devices which provide a means of indicating a cumulative exposure to time and temperature. A TTI device may be capable of indicating whether a commodity has been exposed to a temperature greater than a predetermined temperature for a period of time or to an integral value of time and temperature. For example, a device might indicate exposure to an excessive temperature for an excessive time. A large number of time-temperature indicators and time indicators devices for monitoring thermal degradation of perishables and self-expiring labels, tickets and badges have been reported in the patent literature. Many of these devices are based on diffusion of a chemical from one matrix to the other, sometimes through a barrier, to introduce color change in the indicator in the other matrix. The term used color change herein includes change in optical density including change in fluorescence and transparency. Other TTIs are based on chemical reactions, such as the solid state polymerization of diacetylenes and diffusion based devices.

In order to monitor freezing of certain perishable items such as blood, vaccines and produce freeze indicators are used and in order to monitor thawing of frozen foods thaw indicators are used. Some of these temperature indicators also have features of time-temperature indicators. There are also sharp temperature indicators. These sharp temperature indicator shows, reversible and irreversible color change within a narrow temperature range. All these indicators herein are referred to as temperature indicators.

Medical supplies and certain perishables are sterilized by processes and materials, such as steam, ethylene oxide, formaldehyde, dry heat, peroxides such as hydrogen peroxide and peracetic acid, plasma and ionizing radiation. The sterilization processes also depend upon time and temperature of sterilization. Color changing indicators in form of labels are used for monitoring sterilization. The sterilization indicators are similar to time-temperature indicator with one or more parameter, e.g., steam in the processes. These indicators are not tamper evident. Hence, there is a need for making the sterilization indicator tamper evident.

The time, temperature (including freeze and thaw indicators), sterilization and time-temperature indicators, including those defined above, individually or collectively are referred herein as TTID (time, temperature indicating devices). TTID are the devices which have capability of monitoring at least time, temperature or integral value of time and temperature. TTID can be color changing or self reading. We have used the terms TI, TTI, Temp and TTID interchangeably herein. We have also used the word indicator and monitor interchangeably.

A large number of devices have been reported in the patent literature for monitoring time, temperature (including freeze and thaw) and integral value of time and temperature. The following patents are some representative examples of those devices: U.S. Pat. Nos.: 2,896,568; 3,018,611; 3,046,786; 3,078,182; 3,311,084; 3,520,124; 3,921,318; 3,954,011; 3,962,920; 3,999,946; 4,154,107; 4,195,058; 4,212,153; 4,382,063; 4,404,922; 4,432,630; 4,432,656; 4,448,548; 4,480,749; 4,542,982; 4,573,711; 4,629,330; 4,643,122; 4,643,588; 4,646,066; 4,737,463; 4,779,120; 4,812,053; 4,846,095; 4,846,502; 4,917,503; 5,053,339; 5,058,088; 5,120,137; 5,293,648; 5,317,980; 5,364,132; 5,378,430; 5,446,705; 5,602,804; 5,633,836; 5,667,303; 5,699,326; 5,709,472; 5,715,215; 5,719,828; 5,785,354; 5,822,280; 5,862,101; 5,873,606; 5,930,206; 5,957,458; 5,974,003; 5,997,927; 6,042,264; 6,103,351; 6,214,623; 6,254,969; 6,514,462; 6,524,000; 6,536,370; 6,614,728; 6,752,430; 6,822,931; 6,916,116; 7,156,597; 7,157,048; 7,209,042; 7,280,441; 7,290,925 and 7,294,379. All these patents are hereby incorporated by reference into the specification of the present invention.

None of the devices disclosed in the above patents and those available commercially are tamper indicating or temper evident. The phases “tamper indicating” and “tamper evident” are used interchangeably herein. Those reported in the literature and commercially available TTIDs are tamperable, e.g., an indicator can be opened, removed, repositioned, exchanged or replaced. With certain products, such as vaccines and blood, use of tampered time-temperature indicator, may risk or threaten the life of the user. In case of time indicators for visitors badges can risk or threaten the security of an organization. The risk and liability are high if the tampered indicators are used or TTIDs are tempered with. Hence, there is a need for tamper evident time, temperature, sterilization, time-temperature, freeze and thaw indicating devices. For example, if an indicator is opened, replaced, exchanged or removed, it will be either destroyed or will provide a visual indication or a message, such as “VOID” or “TAMPERED”.

The tampering with and adulteration of many commercially available products has become a critical problem endangering health. Many products which are adulterated or tampered with ultimately reach a consumer bearing no indication that such adulteration or tampering has occurred. Tamper evident labels are used to indicate when a label or a package containing the label has been altered. They often provide an irreversible visual indication of tampering. Such a label is often referred to as a tamper-evident label or tamper-evident indicator.

Tamper evident labels/stickers/tapes are well known and a variety of them are available commercially. A common tamperevident tape or label is applied directly to a container or package. This type of tape or label has one appearance when applied to the package, and takes on a second, different and distinct appearance when it is removed. When the tape is removed, it leaves behind some indication, such as “X”, “VOID” or “OPENED” to indicate that the container has been opened or tampered. If the tape is reapplied to the package, it retains the second appearance. A layer which is responsible for separating the top (film) and bottom (adhesive) layers is typically made from a peeling agent, such as silicone or Teflon type not-sticking, very low surface energy materials. Silicone layer or the peeling agent layer is also referred herein as release pattern or release layer. The release pattern could be in form of a message, such as void, tampered, expired, barcode and images. A peeling agent layer facilitates the separation between the layers.

Other known tamper evident tapes and labels use a tape at least one layer of which includes continuous webs of fracture or cuts in a known and pre-designated manner. When removed, such tape will fragment and the interconnecting portion between the tape and the container or product to which it is attached will indicate that the tape has been tampered with.

In addition, various types of tamper-evident labels are made from rigid or brittle polyvinylchloride and cellulose acetate materials. The rigid, brittle material is easily susceptible to destruction if any external mechanical stresses are exerted. This type of destructible film/label is used more widely on consumer medicines and food packaging that flakes when an attempt is made to peel it away.

A large number of patents have been issued on tamper evident devices.

U.S. Pat. No. 4,121,003 discloses tamper evident labels comprising a laminate of a transparent outer sheet having a tamper-indicated, information-containing pattern printed on its inner surface and a pressure sensitive adhesive film coated on the printed inner surface of the outer sheet.

U.S. Pat. No. 4,721,638 relates to materials that prevent re-sticking. The materials have an adhesive layer, a second layer, a peeling agent layer laminated on the second layer and a first layer laminated on the peeling agent layer. The second and first layers are adhered via the peeling agent layer. Once the first layer and the second layer are separated they cannot be re-stuck together.

U.S. Pat. No. 4,738,472 discloses a tamper-evident label that includes a water-activated adhesive and a temperature sensitive dye.

U.S. Pat. No. 4,746,556 relates to easily breakable sticking material. The material has a surface layer, an easily breakable layer laminated to the surface layer, a first peel-off layer formed on the surface of the easily breakable layer, a second peel-off layer formed on a part of the main surface of the easily breakable layer, a covering layer and an adhesive layer. The surface layer is peeled off of the easily breakable layer and cannot be re-adhered again.

U.S. Pat. No. 4,876,123 discloses a tamper evident tape including a delaminating film which delaminates internally between first and second major surfaces. The tamper evident tape also includes colored indicia printed on the major surfaces of the film and an adhesive means for adhering the film to a substrate.

U.S. Pat. No. 5,013,088 discloses disintegratable masking labels which have a plurality of cuts in the label such that upon tampering, portions of the label remain bonded to the substrate and the remaining label fragments show evidence of tampering of the label.

U.S. Pat. No. 5,042,842 relates to labels, such as those used for preventing or detecting tampering and counterfeiting. The label is a multilayer security label which has a base layer with a permanent adhesive coated on a lower surface. Indicia or markings are applied to the bottom surface of the top layer and the top layer is laminated to the upper surface of the base layer. The top layer is laminated to the upper surface of the base layer by permanent patterned adhesive. A portion of each of the upper surface of the base layer and the bottom surface of the top layer are free of adhesive.

U.S. Pat. No. 5,319,475 discloses a tamper-evident label that includes an optical diffraction pattern that undergoes an irreversible change if tampered with, heated, or chilled.

U.S. Pat. No. 5,411,295 discloses a tamper-evident label that includes water-soluble and water-insoluble indicia or graphics.

U.S. Pat. No. 6,149,203 discloses a tamper-evident label that includes an imprinted pattern of adjoining matte and high-gloss areas.

U.S. Pat. No. 6,303,202 discloses a tamper-evident label that includes a paper ply and printed matter sealed in a resin and a liner ply that defines a label portion and a removable portion.

U.S. Pat. No. 6,326,071 discloses a tamper-evident label that includes a thermally-imprintable color producing layer.

Other patents include U.S. Pat. Nos.: 3,415,402; 3,740,081; 3,801,183; 3,925,584; 4,098,577; 4,184,701; 4,479,585; 4,502,605; 4,505,399; 4,516,679; 4,630,891; 4,652,473; 4,873,193; 4,890,763; 4,931,327; 5,080,463; 5,169,707; 5,217,307; 5,364,333; 5,495,944; 5,405,692; 6,214,443; 6,365,255; 6,713,152 and 7,095,324. All these patents on tamper indicators are hereby incorporated by reference into the specification of the present invention.

Many of these tamper evident devices, e.g., in form of rolls and labels are available commercially , e.g., from 3M (Product #3921, #7385, #7847, #7866, #7610 and #7900).

There is also a need for maintaining the security of perishable packages and monitor shelf life. Even if a shelf life indicator is on the package, often consumers do not notice. There is also a need for consumers of perishables to easily notice tampering of perishable package and notice the shelf life. This can be best achieved by placing a tamper evident shelf life indicator at or near the mouth of the container/package or the closer in such a way that consumer has to break the shelf life indicator and hence has a better chance of noticing tampering and shelf life. This can be best done by placing a tamper evident TTID at or near the closer of the container/package.

In spite of the myriad of tamper evident and TTID devices know in the art, there remains a need for general purpose TTID devices which are also tamper evident.

### BRIEF DESCRIPTION OF THE DRAWINGS

FIG. 1 illustrates a schematic cross sectional view (a) of a non-TTID tamper evident label, and its top views before (b) and after (c) peeling the label (a prior art).

FIG. 2 illustrates schematic cross sectional view (a) of a tamper evident TTID on a tamper evident layer, and its top views before (b) and after (c) peeling the TTID.

FIG. 3 illustrates a schematic cross sectional view (a) of a tamper evident TTID under a tamper evident layer, and its top views before (b) and after (c) peeling the TTID having tamper evident layer larger than TTIb.

FIG. 4 illustrates a schematic cross sectional view of an activated two-tape time-temperature indicator without a tamper indicator (prior art).

FIG. 5 illustrates a schematic cross sectional view of an activated tamper evident two-tape time-temperature indicator with a release pattern under the indicator substrate.

FIG. 6 illustrates a schematic cross sectional view of an activated tamper evident two-tape time-temperature indicator with a release pattern on the activator substrate.

FIG. 7 illustrates a schematic cross sectional view of an activated tamper evident two-tape time-temperature indicator with a release pattern between the indicator and activator layers.

FIG. 8 illustrates a schematic cross sectional view of an activated tamper evident two-tape time-temperature indicator with two release patterns.

FIG. 9 illustrates a schematic cross sectional view of an activated tamper evident two-tape time-temperature indicator with a release pattern under the device.

FIG. 10 illustrates a schematic cross sectional view of a tamper evident TTID having a destructible layer over the basic device.

FIG. 11 illustrates a schematic cross sectional view of a tamper evident TTID having a destructible layer and an adhesive layer.

FIG. 12 illustrates a schematic cross sectional view of a tamper evident TTID having a destructible layer and an adhesive layer under the basic device.

FIG. 13 illustrates a cross sectional view of a tamper evident TTID based on single coating undergoing color changes and having destructible layers.

FIG. 14 illustrates cross sectional view of a tamper evident TTID based on single coating undergoing color changes and having destructible layers and release pattern.

### BRIEF DESCRIPTION AND OBJECTS OF THE INVENTION

It is an object of this invention to provide for a tamper evident TTID (TETTID) which comprises a TTID and at least one tamper evident layer.

It is a further object of the invention to provide a TETTID having one or more of the following layers: at least one substrate, at least one color developing, color changing and transparency changing indicator layer for monitoring one or more of time, temperature, concentration, time-temperature, freeze, thaw, pressure, radiation, sterilization and alike, at least one adhesive layer, and at least one TElayer. Examples of substrate include metallized and un-metallized plastic films, such as that made from polyethylene, polypropylene and polyester. Examples of color developing, color changing and transparency changing indicators and indicator layers include those disclosed our U.S. Provisional Patent Application Nos. 61/130,928; 61/132,799; 61,081,763; 61/095,058; 61/122,547 and 61/162,539 filed on Jun. 4, 2008; Jun. 23, 2008; Jul. 18, 2008; Sep. 8, 2008; Dec. 15, 2008 and Mar. 23, 2009 respectively, which are incorporated herein by reference in their entireties and in patents listed in prior art herein for time, temperature and time-temperature indicators. Examples of adhesives include those listed herein under adhesives and those listed in prior art cited herein. Examples of tamper indicators include those disclosed in patents listed in prior art.

It is a further object of the invention to provide a tamper evident TTID for monitoring time, temperature, integral value time, temperature, time and temperature or shelf life, freezing, thawing, radiation and sterilization.

It is a further object of the invention to provide a TETTID undergoing either reversible or irreversible change in optical density comprising a color reference bar.

A further object of the invention is a TETTID undergoing either reversible or irreversible change in transparency.

Yet another object of the invention is to provide a TETTID in form of label, sticker, film or tape.

A further object of the invention is to provide a TETTID comprising at least one layer having capability of changing color or transparency when subjected to time, temperature, time-temperature, radiation or chemicals.

A further object of the invention is to provide a TETTID having at least one substrate, destructible layer, adhesive layer, release pattern, metallized plastic film, destructive plastic film, or release pattern.

A further object of the invention is to provide a TETTID where said release pattern is a message of tampering comprising void, tampered, don't use and expired.

A further object of the invention is to provide a TETTID having a TElayer either on, under or inside a layer for monitoring time, temperature or time-temperature.

A further object of the invention is to provide a TETTID applied on an object, where said object is a person, clothing, perishable, container, closer, or closer and container.

A further object of the invention is to provide a TETTID having a destructible layer composed of brittle or breakable material made from brittle polyvinyl chloride, cellulose acetate, polystyrene, epoxy or highly crosslinked polymers.

A further object of the invention is to provide a TETTID where the said layers are opaque, clear, or colored.

A further object of the invention is to provide a TETTID where said adhesive layer further contains a release pattern.

A further object of the invention is to provide a process of making a TETTID by lamination of one or more of the following layers: at least one substrate, at least one color developing, color changing and transparency changing indicator layer for monitoring time, temperature and/or time-temperature, at least one adhesive layer, and at least one tamper evident layer.

A further object of the invention is to provide a TETTID where said TTID is on or under a tamper evident layer.

A further object of the invention is to provide a process of monitoring tampering of the said devices.

A further object of the invention is to provide a process of monitoring shelf life and expiration of time.

A further object of the invention is to provide a process of monitoring tampering of a TETTID by de-lamination of two different layers of the said device.

A further object of the invention is to provide a process of monitoring tampering of TTID by determining destruction of a layer.

A further object of the invention is to provide processes, such as color and transparency change due to polymerization, diffusion, wicking, photochromism, change in pH and etching of a metal is used for monitoring time, temperature, time-temperature, freeze, thaw, radiation and sterilization of said TTIDs.

A further object of the invention is to provide process of applying the said TETTID applied on medical supplies.

A further object of the invention is to provide TETTID for monitoring sterilization of a medical supply or a perishable with steam, ethylene oxide, formaldehyde, plasma, dry heat or ionizing radiation.

A further object of the invention is to provide a flat multilayer TETTID having at least one layer or one pair of layers which when separated or tampered, the tampering is indicated visually noticeable evidence.

### DETAILED DESCRIPTION OF THE INVENTION

This invention relates to a tamper evident time, temperature indicating device (TTID) which comprises a TTID; at least one tamper evident layer; and a means for securely attaching the TETTID to the item to be monitored.

More particularly, the invention relates to a TETTID having one or more of the following layers: a) at least one substrate, b) at least one color developing, color changing or transparency changing indicator layer for monitoring one or more of time, temperature, concentration, time-temperature, freeze, thaw, pressure, radiation, sterilization and alike (TTID layer), c) at least one adhesive layer, and d) at least one tamper evident layer.

In another embodiment of the invention, the tamper evident layer or the adhesive layer further contains a release pattern.

In a further embodiment of the invention the release pattern is a message of tampering comprising terms such as but not limited to “void”, “tampered”, “don't use” and “expired”.

In one embodiment of the invention, the multilayer TETTID has at least one layer or one pair of layers which, when separated or tampered, indicates by visually noticeable evidence that the device has been tampered.

In another embodiment of the invention the TETTID further comprises a destructive layer.

In yet another embodiment of the invention, the destructive layer comprises destructible layer composed of brittle or breakable material made from brittle polyvinyl chloride, cellulose acetate, polystyrene, epoxy or highly crosslinked polymers.

The TETTID of the invention may have a tamper evident layer either on, under or inside a layer for monitoring time, temperature or time-temperature, wherein the layers are opaque, clear, or colored.

In another embodiment is provided a TETTID in form of label, sticker, film or tape.

In yet another embodiment of the invention the TETTID is applied on a object, where said object is a person, clothing, perishable, container, closer, closer and container.

Another embodiment of the invention is a process of making a TETTID by lamination of one or more of the following layers: a) at least one substrate, b) at least one color developing, color changing and transparency changing indicator layer for monitoring time, temperature and/or time-temperature, c) at least one adhesive layer, and d) at least one tamper evident layer.

An embodiment of the invention is a process of monitoring tampering of the said devices by determining a change in the destructible layer of the device of the invention. In one embodiment, at least one layer of the device is delaminated. In another embodiment, the destructible layer is destroyed.

In one embodiment of the invention, the TETTID is used to monitor shelf life or expiration of time of the product to which it is adhered. The TETTID can be applied on medical supplies or perishables. It can be used for monitoring sterilization of a medical supply or a perishable. The sterilization can be carried out with the use of steam, ethylene oxide, formaldehyde, plasma, dry heat or ionizing radiation.

In a specialized embodiment, processes, such as color and transparency change due to polymerization, diffusion, wicking, photochromism, change in pH and etching of a metal are used for monitoring time, temperature, time-temperature, freeze, thaw, radiation and sterilization of said TTIDs.

Examples of substrate include metallized and un-metallized plastic films, such as those made from polyethylene, polypropylene and polyester or other films known in the art as well as additional materials listed below.

Examples of color developing, color changing and transparency changing indicators and indicator layers include those disclosed in U.S. Provisional Patent Application Nos. 61/130,928; 61/132,799; 61,081,763; 61/095,058; 61/122,547 and 61/162,539 filed on Jun. 4, 2008; Jun. 23, 2008; Jul. 18, 2008; Sep. 8, 2008; Dec. 15, 2008 and Mar. 23, 2009 respectively and in patents listed in prior art herein for time, temperature and time-temperature indicators (TTID layer). In certain embodiments, the TTID layer is capable of undergoing either reversible or irreversible change in either optical density by comprising a color reference bar or in transparency, when the TETTID is subjected to time, temperature, time-temperature, radiation or chemicals.

Examples of adhesives include those listed herein under adhesives and those listed in prior art cited herein.

Examples of tamper indicators include those disclosed in patents listed in prior art.

Examples of substrate include plastic films such as that made from polyethylene, polypropylene, polyester and a metallized plastic.

Examples of color developing or color changing indicators and indicator layers include those disclosed in patents listed in prior art herein for time, temperature, time-temperature indicators, sterilization and other indicators.

Examples of tamper indicators include those disclosed in patents listed in prior art including the prior art listed in herein.

The TETTID can best be described by reference to the Figures.

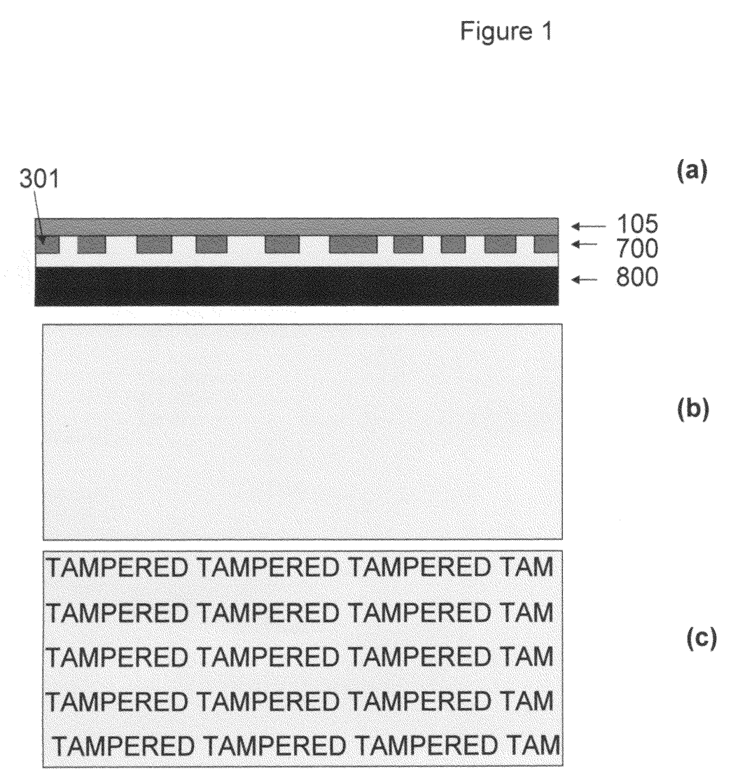

A schematic presentation of a tamper evident film or label, as a prior art is shown in FIG. 1. A cross sectional view before its application and removing the substrate is shown in FIG. 1(a) and top views before and after applying the label and peeling off the substrate, 105 is shown in FIG. 1(b) and 1(c) respectively. A tamper evident label/film, similar to that shown in FIG. 1 can be made by coating a substrate, 105 with a release pattern, 301, e.g., “TAMPERED” or “VOID” with a release material, such as silicone release ink. A pressure sensitive adhesive (PSA), 700 containing a colorant, such as pigment is coated over the substrate having the release pattern. The PSA bonds strongly with the substrate while bonds very weakly with the release pattern. A release layer 800, e.g., silicone coated paper or film is applied on the PSA. When release layer, 800 is removed and the film/label is applied on a substrate, the release pattern, e.g., TAMPERED, is not visible as shown in FIG. 1(b). However, when the substrate is removed, the release pattern become visible, e.g., word “TAMPERED” or “VOID”, as shown in FIG. 1(c). There are many other ways to create a tamper evident films or labels as disclosed in patents listed in the prior art.

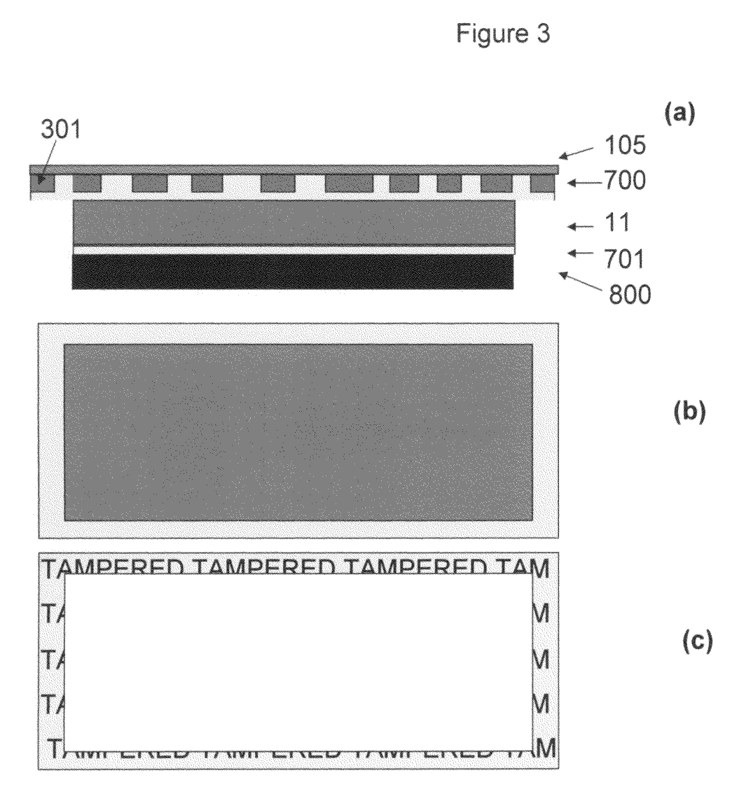

There are a number of different ways a TETTID can be created. Some examples are shown schematically in FIGS. 3 and 5-14.

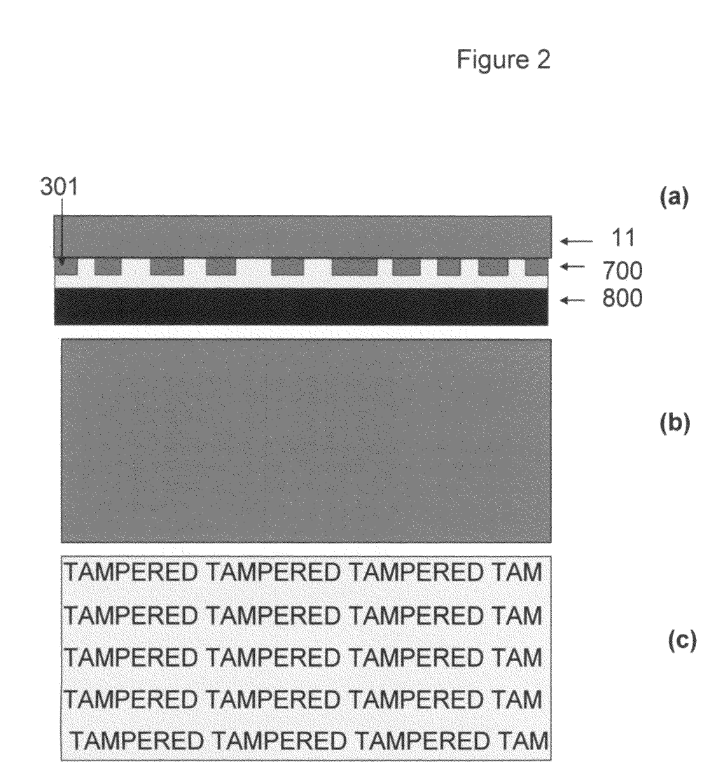

FIG. 2(a) shows a TTID, 11 applied on a tamper evident tape (similar to 20 that shown in FIG. 1) composed of a PSA layer, 700 containing a release pattern 301 and a release liner 800. The TTID, 11 can be a prior art (e.g., those available commercially) or a new TTID. When the TETTID of FIG. 2(a) is applied on an object after removing the release layer 800, one can see the color of the tamper evident tape or that of a TTID as shown in a top view in FIG. 2(b). If the TTID is removed, the word “TAMPERED” or “VOID” will be visible, as shown in a top view in FIG. 2(c). Applying a TTID on a tamper evident layer is one of the simple ways to make a TTID into a TETTID.

As an alternative to FIG. 2, the TTID can be covered with a transparent or translucent tamper evident tape. The TTID can be fully, partially or over covered with a tamper evident tape. A TTID over covered with a tamper evident tape is shown in a cross sectional view in FIG. 3(a). After removing the release layer 800, the TETTID can be applied on an object. It will then appear as shown schematically in FIG. 3(b). The TTID can't be accessed without removing the tamper evident tape. If an attempt is made to remove the TTID or the tamper evident tape, depending upon the coverage and the attempt, the word “TAMPERED” or a portion thereof will appear as shown in a top view in FIG. 3(c). Applying TTID under a tamper evident layer is one of the simple ways to make a TTID into a TETTID.

A variety of TTID devices are available commercially. Making a TTID tamper evident depends upon the design and processes of making them TTID.

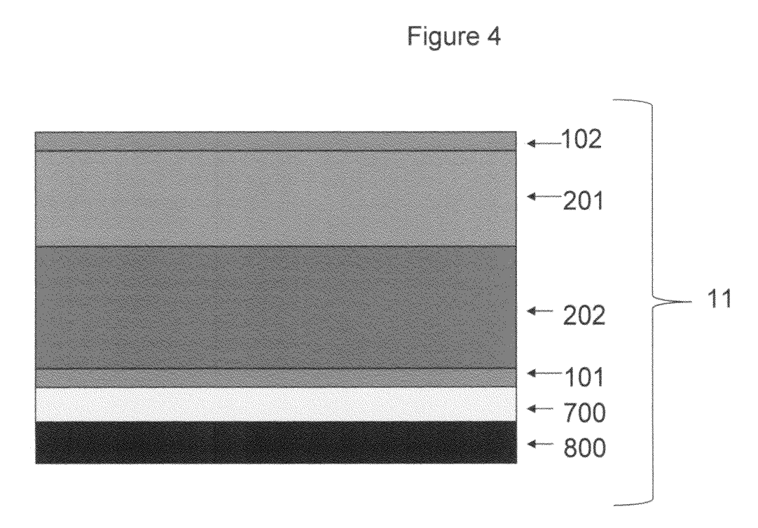

An example of a non-tamper evident, two-tape TTID (both time and time-temperature indicating) is shown in FIG. 4. The TTID shown in FIG. 4 is described in U.S. Pat. No. 5,053,339 and referred herein as a two-tape TTID. The two-tape device is made, for example, by applying an indicator tape over an activator tape made separately. An indicator tape is made by applying an indicator layer 201, e.g., composed of a PSA containing an indicator on a transparent substrate 102. An indicator is a composition, e.g., a pH dye, which changes color when contacted with an activator, e.g., an acid or a base. An activator tape is made by applying an activator layer 202, e.g., composed of a PSA containing an activator composition, e.g., an acid or a base, on an opaque substrate 101, having a PSA layer, 700 and a release layer, 800 as shown in FIG. 4. An activator is a composition which changes color of an indicator. The activator and the indicator tapes are made separately and applied to make/activate the TTID.

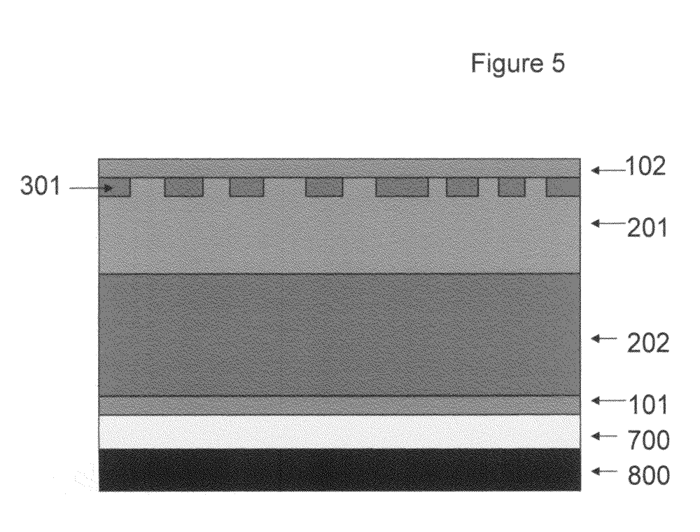

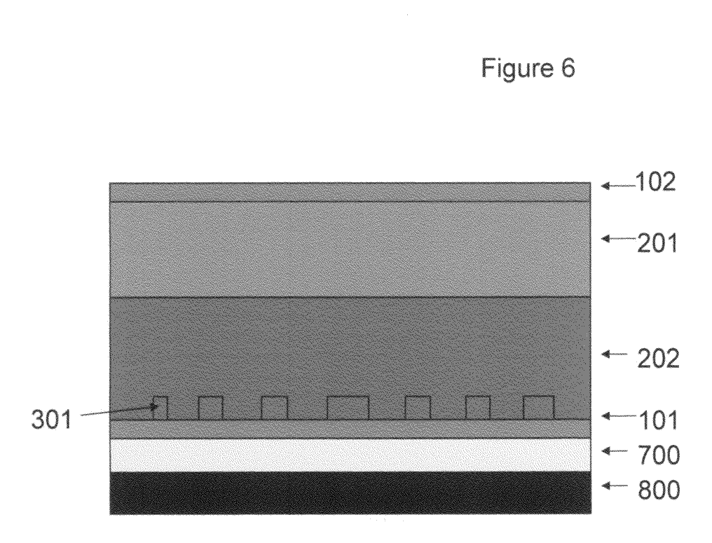

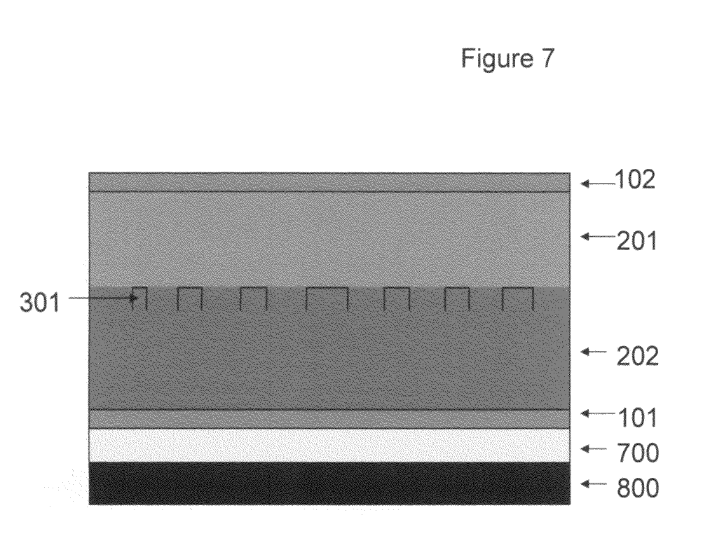

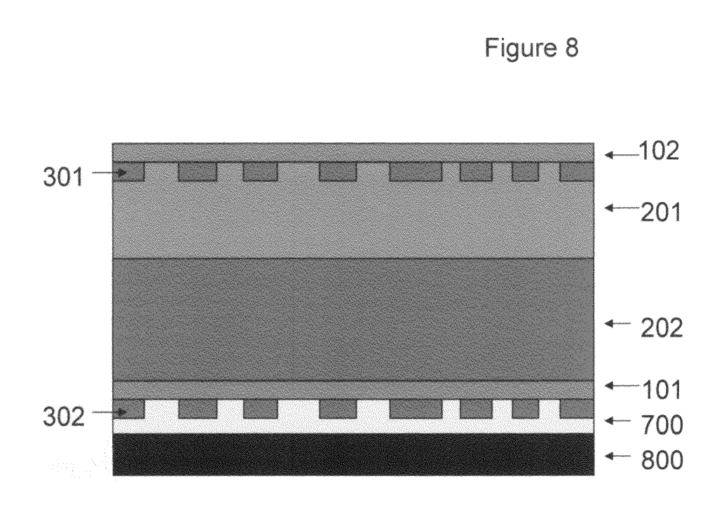

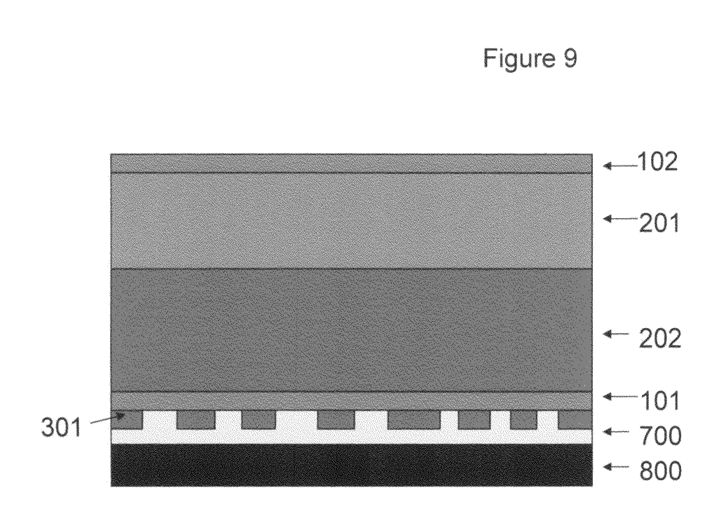

The two-tape and other TTIDs can be made tamper evident by many different ways. For an example, the release pattem, 301 can be created under the indicator substrate, 102 as shown in FIG. 5, on the activator substrate, 101 as shown in FIG. 6 or between the activator layer, 202 and the indicator layer, 201 as shown in FIG. 7. There could be more than one release patterns 301 and 302, as shown in FIG. 8. These types of devices will indicate if the TTID itself is tampered. However, a simple way to create a tamper indicator TTID is to have the release pattern, 301 in the backing adhesive, 700 as shown in FIG. 9. Any attempt to peel or tamper the TTID devices of FIGS. 5-9 and similar devices will be indicated by appearance of the release pattern.

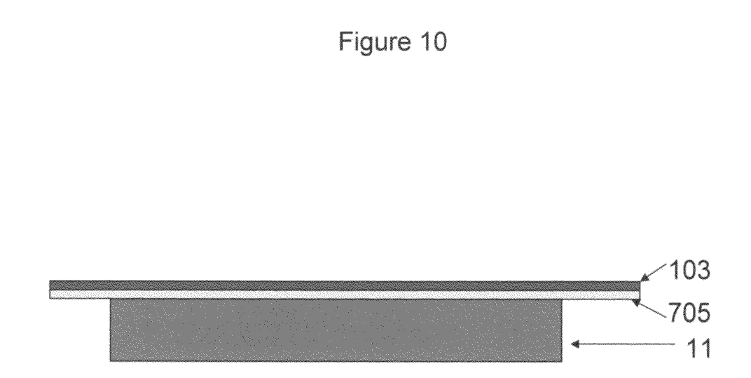

Another way to make a TETTID is to use destructible film as a substrate, matrix or support. Examples are shown in FIGS. 10-12. The basic TTID device, 11 such as those available commercially can be cover with a destructible temper evident film, 103 having an adhesive layer, 705. Tamper evident destructible film made from brittle plastics (e.g., unplasticized polyvinyl chloride, polystyrene and solution casted cellulose acetate) are available commercially. Under certain circumstances, stretchable materials, such as rubber can be used instead of destructible films.

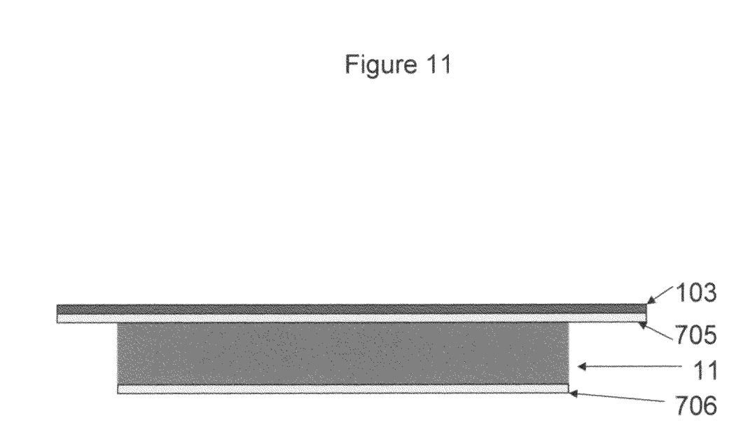

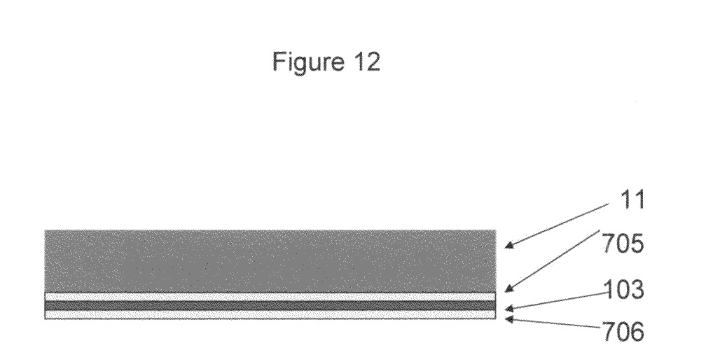

The basic TTID device, 11 in FIGS. 10-12 can be applied on the destructible substrate substrate/film, 103 with an adhesive layer 705. In order to apply these TETTIDs, one may need to use another adhesive layer, 706 as shown in FIGS. 11 and 12. The rigid, brittle material is easily susceptible to destruction if any external mechanical stresses are exerted. Hence, when an attempt is made to tamper (e.g., peel) the TTID, it will be evident.

It is also possible to make the TETTID by replacing one or more layers/substrates of devices shown in FIGS. 4-9 with a destructible (e.g., breakable, rigid or brittle) films such as that made from rigid polystyrene, polyvinylchloride or cellulose acetate. Depending upon the location, the destructible layer could be opaque, transparent or translucent. The bottom layer could be opaque while the top layer preferably should be transparent or translucent.

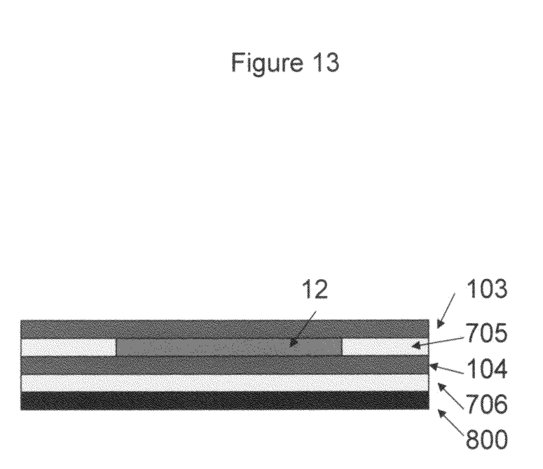

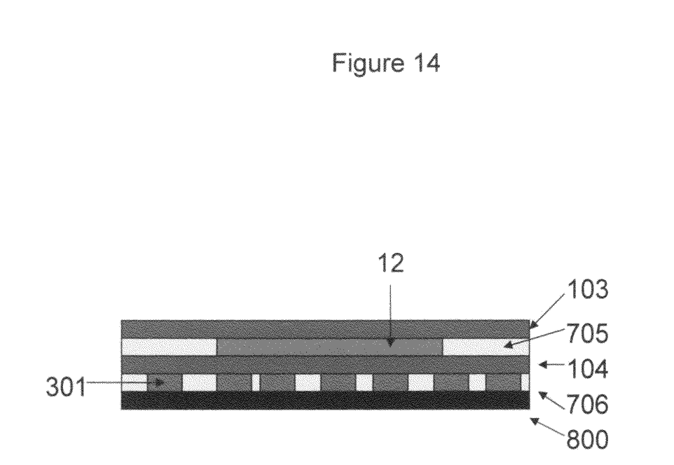

When the color changing layer of a TTID is a simple thin coating, e.g., those based on polymerization of diacetylenes (as first disclosed in U.S. Pat. No. 3,999,946), the TETTID can be made from destructible layers as shown in FIGS. 13 and 14. A color changing composition, 12 can be coated on a destructible, preferably opaque film/layer, 104 having an adhesive layer, 706 and a release layer, 800. This assembly is then laminated with another layer of destructible layer/film, 103 having an adhesive layer, 705. Optionally, the adhesive layer, 706 can be colored and can have a release pattern, 301 as shown in FIG. 14. The TTID of FIG. 14 will be both destructible if tampered and leave a message.

The color indicating compositions and layers of the TETTIDs in FIGS. 2-14 could be continuous or broken (e.g., in any shape, barcode or message).

The tamper evident devices will have all other basic characteristics and feature, e.g., color reference bars and use instructions as in non-tamper evident TTIDs.

In addition to the layers described in FIGS. 1-14, the TETTID could have additional layers of a resin which may or may not be (1) adhesive, (2) contain a release pattern, (3) destructible layer and (4) indicators for time, temperature and time-temperature.

It is also possible to make tamper evident devices by using heat shrinkable films, materials containing fluorescence dyes and pigments, holograms and color shifting film (e.g., DUN-GUARD™, Dunmore, Bristol, Pa.) The preferred shape of the release pattern is a message, such as “TAMPERED”, “VOID”, “EXPIRED” or “DON'T USE” but it could be of any kind, shape, size and/or form.

Tamper evident metallized plastic films (a film having a silicon release pattern and vaporized metal layer) can also be used to make tamper evident TTID. The plastic film of the tamper evident metallized film could be destructible as well. The devices disclosed in our U.S. Provisional Patent Application Nos. 61/130,928; 61/132,799; 61,081,763; 61/095,058; 61/122,547 and 61/162,539 filed on Jun. 4, 2008; Jun. 23, 2008; Jul. 18, 2008; Sep. 8, 2008; Dec. 15, 2008 and Mar. 23, 2009 respectively can also be made temper indicating by using the designs and processes disclosed herein.

Any one layer of a TETTID could be colored, e.g., yellow, red or blue. Red color layer is preferred especially for the devices requiring protection from sunlight, such as those sensitive to UV and near UV visible light.

The TETTID can also be applied on to the closer of the container and the container itself by pressing the exposed surface of the adhesive layer after removing the release sheet. This way, it is likely that the user will notice and read the TTID before using the content of the container and if the container and/or the TTID have been tampered.

Destructible films are often used as a means for providing security to articles and documents. Typically, these destructible films are provided in a multilayered environment wherein the tampering forces break a portion of the destructive film thereby providing the indication of tampering.

The frangible layer may be prepared from film forming polymer or a deadened adhesive layer which is brittle or very thin. Examples of these polymers include polystyrene, thin epoxy polymers or unplasticized vinyl polymers, such as unplasticized polyvinyl chloride or fluoride.

Brittle films can also be made by crosslinking, e.g., by photopolymerization or thermal curing.

The size of the TETTID can be as small as a few square millimeters to several square centimeters or larger, if desired. The thickness of the device typically can be from a thousandth of a centimeter to a millimeter, or thicker, if desired.

### Substrate Film:

The polymer films include polyolefins (linear or branched), polyamides, polystyrenes, nylon, polyesters, polyester, polyurethanes, polysulfones, styrene-maleic anhydride, styrene-acrylonitrile, ionomers based on sodium or zinc salts of ethylene methacrylic acid, polymethyl methacrylates, cellulosics, acrylic polymers (acrylates such as ethylene methacrylic acid, ethylene methyl acrylate, ethylene acrylic acid and ethylene ethyl acrylate), polycarbonates, polyacrylonitriles, ethylene-vinyl acetate and their copolymers can be used as substrate for the devices.

Adhesives, for example, include the use of synthetic elastomers, acrylates, silicone, synthetic latex and vinyl acetate, as representative examples of pressure sensitive adhesives (PSA) are one of the preferred material for the PSA layer. Included are pressure sensitive adhesives having an elastomer or rubbery polymer as the elastic component and a low molecular weight tackifying viscous component. Common rubber based pressure sensitive adhesives include natural elastomers, synthetic elastomers such as polychloroprene, polyurethane, and random and block copolymers of styrene-butadiene, styrene-isoprene, polyisobutylene, butyl rubber, and amorphous polypropylene. These are compounded with tackifying resins to formulate hot melt pressure sensitive adhesives. Common acrylic adhesives such as polymers of 2-ethylhexylacrylate, butyl acrylate, ethylacrylate, and acrylic acid can be used. These acrylic adhesives are inherently pressure sensitive. Polymers and copolymers of vinyl ethers such as vinylmethylether, vinylethylether and vinylisopropylethers are used as pressure sensitive adhesives. Two types of silicone gums; 1) all methyl based and 2) the phenyl modified can also be used as pressure sensitive adhesives. The silicone resin is used as a tackifier and by adjusting the resin to gum ratio, they can be made with a wide range of adhesion properties. High silicone gum content adhesives are extremely tacky. Silicone adhesives are also crosslinked (cured) by catalysts such as benzoyl peroxide and amino silane.

Hot melt pressure sensitive adhesives typically comprise a block copolymer, a tackifying resin and a plasticizing oil can also be used. The block copolymer provides flexibility, integrity and smooth peel adhesion properties. It also further provides a medium for dissolution or suspension of the tackifying resin and the plasticizing oil. The tackifying resin enhances tack properties and adhesion and reduces viscosity and the plasticizing oil reduces peel values, viscosities, glass transition temperatures and storage modulus and increases flexibility. The low ultimate peel value and lower peel adhesion of the removable adhesive is achieved through the use of higher polymer and plasticizing oil concentrations and lower tackifying resin concentrations in the adhesive.

The release layer could be composed of a material which does not bond or bond very weekly with a PSA. The release materials include silicone, Teflon or oils.

Assembled TTIDs can be prepared in the form of big rolls and stored. The rolls can subsequently be loaded onto a suitable processing machine/equipment. In order to activate the device, the release layer is removed and applied to an object depending upon the TTID and application. Commercially available equipment for application of labels can be used.

Tamper TTIDs include sterilization, time, temperature, time-temperature indicating devices. Temperature indicators also include freeze and thaw indicators. Preferred are irreversible indicators but reversible indicators are also included this definition.

The TETTID disclosed herein can be used (1) as time temperature indicators for perishables, (2) as time indicator and (3) temperature indicator as listed in the prior art herein.

### EXAMPLES

### Example 1

### Void Message

A few commercially available TTIs, such as that obtained from Temptime, Morris Plains, N.J. and Avery Dennison, Pasadena, Calif. were applied on a tamper evident metallized polyester film. When the TTI devices were peeled, the word “VOID” appeared.

### Example 2

### Destructible TTIDs

The commercially available TTIs of example 1 were applied on a clear destructible cellulose acetate film having a PSA with the top of the TTI devices facing the adhesive. The tamper evident devices thus made were then applied on a glass bottle. The TTI devices were clearly visible. Attempts were made to remove the devices with nails and a knife. The devices can't be removed in one piece. Outer edges of the cellulose acetate film started breaking while being removed.

### Example 3

### Diacetylene Based Device

On an opaque cellulose acetate tamper evident film having a PSA and a release liner was coated with a water based emulsion of a diacetylene (R—C═C—C═C—R, where R═CH₂—OCONH(CH₂)₅CH₃.). When coating was dried it was laminated with a clear cellulose acetate film having a PSA. The tamper evident device thus made was applied on a glass container by removing the release liner. The device can't be removed in one piece. The device started breaking while being removed. The device developed noticeable red color within one hour when place in an oven at 50° C.

1. A tamper evident device (TETTID) which comprises a time, temperature indicating device (TTID); at least one tamper evident layer; and a means for securely attaching the TETTID to the item to be monitored.

2. The TETTID of claim 1 having one or more of the following layers: a) at least one substrate, b) at least one color developing, color changing or transparency changing indicator layer for monitoring one or more of time, temperature, concentration, time-temperature, freeze, thaw, pressure, radiation, or sterilization (TTID layer), c) at least one adhesive layer, and d) at least one tamper evident layer.

3. The TETTID of claim 2 wherein the tamper evident layer or the adhesive layer further contains a release pattern.

4. The TETTID of claim 3 wherein the release pattern is a message of tampering comprising terms selected from “void”, “tampered”, “don't use” and “expired”.

5. The TETTID of claim 2 wherein the TETTID has at least one layer or one pair of layers which, when separated or tampered, indicates by visually noticeable evidence that the device has been tampered.

6. The TETTID of claim 2 wherein the TETTID further comprises a destructive layer.

7. The TETTID of claim 6 wherein the destructive layer comprises a layer composed of brittle or breakable material made from brittle polyvinyl chloride, cellulose acetate, polystyrene, epoxy or highly crosslinked polymers and wherein the layers are opaque, clear, or colored.

8. The TETTID of claim 2 having a tamper evident layer either on, under or inside a layer for monitoring time, temperature or time-temperature.

9. The TETTID of claim 2 wherein the TTID can undergo a reversible or irreversible change in optical density.

10. The TETTID of claim 2 which further comprises a color reference bar.

11. The TETTID of claim 2 layer wherein the TTID layer has a capability of changing color when subjected to time, temperature or time-temperature.

12. The TETTID of claim 2 wherein the tamper indicator layer is metallized plastic film or destructive plastic film.

13. The TETTID of claim 3 wherein the release pattern is on a substrate.

14. The TETTID of claim 6 wherein the destructible material is a substrate.

15. The TETTID of claim 2 wherein the adhesive layer is pressure sensitive adhesive.

16. The TETTID of claim 2 wherein the adhesive layer is on either the TTID layer or the TElayer.

17. The TETTID of claim 1 where the layers are made by coating

18. The TETTID of claim 1 in the form of a label, sticker, film or tape.

19. The TETTID of claim 1 which is applied on a object, where said object is a person, clothing, perishable, container, closer, or closer and container.

20. A process of making a TETTID by lamination of one or more of the following layers: a) at least one substrate, b) at least one color developing, color changing and transparency changing indicator layer for monitoring time, temperature, radiation, sterilization and/or time-temperature, c) at least one adhesive layer, and d) at least one tamper evident layer.

21. A process of monitoring tampering of a TETTID by determining a change in the destructible layer of the device of the invention.

22. The process of claim 21 wherein the destructible layer is delaminated.

23. The process of claim 21 wherein the destructible layer is destroyed.

24. The process of claim 21 wherein a change in optical density occurs.

25. The process of claim 24 wherein the change in optical density is a color and transparency change due to polymerization, diffusion, wicking, photochromism, change in pH or etching.

26. A process of monitoring the shelf life or expiration of time of a product by adhering to it the TETTID of claim 1.

27. The process of claim 26 wherein the product is a medical product or a perishable material.

28. The process of claim 27 wherein the product has been sterilized.

29. The process of claim 28 wherein sterilization is done by steam, ethylene oxide, formaldehyde, dry heat, peroxide, plasma or ionizing radiation.
